(19) United States
(12) Patent Application Publication
(10) Pub. No.: US 2021/0001814 A1
(43) Pub. Date: Jan. 7, 2021

(54) DRIVE UNIT FOR A WINDOW WIPER SYSTEM

(71) Applicant: VOLKSWAGEN AKTIENGESELLSCHAFT, Wolfsburg (DE)

(72) Inventor: Christopher Daniel NIEHAUS, Wolfsburg (DE)

(21) Appl. No.: 17/040,267

(22) PCT Filed: Oct. 18, 2018
(86) PCT No.: PCT/EP2018/078548

§ 371 Date: Sep. 22, 2020

(30) Foreign Application Priority Data
Mar. 22, 2018 (DE) 10 2018 204 454.6

(51) Int. Cl. B60S 1/08; H02P 6/182; H02P 6/08; H02P 29/60

(52) U.S. Cl. CPC B60S 1/0896; H02P 29/60; H02P 6/08; H02P 6/182

(57) ABSTRACT

A drive unit for a window wiper system having an electronically commutated drive motor, which has a rotor and phase conductors for providing a stator magnetic field; a reversing transmission, which controls one or more wiper arms of a wiper unit in a pivoting motion with alternating direction; a power unit, which provides phase voltages to the drive motor based on control signals and which has a device for measuring phase currents through the phase conductors; and a control unit, which determines a rotor position of the rotor of the drive motor based on the phase currents without using any sensors to generate the control signals based on the rotor position to provide a drive torque and to control rotational speed based on a specified operating function.

### PRIORITY CLAIM

This patent application is a U.S. National Phase of International Patent Application No. PCT/EP2018/078548, filed 18 Oct. 2018, which claims priority to German Patent Application No. 10 2018 204 454.6, filed 22 Mar. 2018, the disclosures of which are incorporated herein by reference in their entireties.

### SUMMARY

Illustrative embodiments relate to a window wiper system having electric drive units and measures to ensure constant wiper operation without increasing the structural complexity.

### BRIEF DESCRIPTION OF THE DRAWINGS

Disclosed embodiments are explained in greater detail below with reference to the appended drawing, in which:

FIG. 1 is a schematic illustration of a window wiper system having a drive unit.

### DETAILED DESCRIPTION

In principle, drive units in window wiper systems are differentiated in accordance with drive units with reversing operation and rotary drives with reversing gear mechanisms. In drive units with reversing operation, an extensive control or regulation which detects the end positions and brings about a reversal of rotation direction of the drive motor is required. This requires complex position detection to determine the end positions for determining the time of the reversal of rotation direction.

On the other hand, drive units which drive the window wiper system using a reversing gear mechanism are often constructed with a rotary motor. A high level of complexity for a position identification is not required since the wiper region is predetermined by the reversing gear mechanism. Simple brush-commutated direct-current motors are often used as rotary motors whose speed depends significantly on the wiping resistance, which is dependent on the wiping position of the wiper blades, and the onboard voltage supply. This often leads to a very noisy wiper operation, which may at least be irritating for the driver.

Furthermore, such drive motors to adjust different speed stages require the use of relays to apply the supply voltage via various series resistors or a plurality of sliding contacts on the commutator to the drive motor. This requires a high level of component complexity and may in addition bring about high power losses in the series resistors.

Document DE 22 182 35 discloses, for example, a speed control for a direct-current motor which can also be used inter alia in window wiper systems. The speed control is carried out by pulse width modulation of a brush-commutated direct-current motor, wherein by selecting the duty cycle the effective supply voltage applied to the direct-current motor can be adjusted.

Document DE 10 2005 019 853 A1 discloses a window wiper system having a direct drive motor. The drive motor may be constructed as a brushless direct-current motor which is controlled together with a position sensor to adjust a speed of the wiper arms and to enable positioning of the wiper arms.

Disclosed embodiments provide an improved drive unit for a window wiper system which can be produced with little complexity, wherein the normal functions of a predetermined continuous wiping speed and the stepped wiping speed control are produced.

This is achieved with the drive unit for a window wiper system and by the window wiper system.

According to a first exemplary embodiment, a drive unit for a window wiper system, in particular, of a transportation vehicle, is provided, comprising:
an electronically commutated drive motor having a rotor and a plurality of phase conductors for providing a stator magnetic field;
a reversing gear mechanism which is coupled to the rotor of the drive motor, in the event of a rotation of the rotor, to control one or more wiper arms of a wiper arrangement in a pivot movement with changing directions;
a power unit which is constructed to provide phase voltages at the drive motor in accordance with control signals and which has a device for measuring phase currents through the phase conductors;
a control unit which is constructed,
   depending on the phase currents, to carry out a sensor-free position detection of a rotor position of the rotor of the drive motor,
   to generate the control signals depending on the rotor position to provide a drive torque, and
   to carry out a speed control depending on a predetermined operating function.

The control unit may further be constructed to generate the control signals as pulse width modulation signals to predetermine variable phase voltages using the power unit.

One notion of the above drive unit involves providing an electronically commutated drive motor which as a rotary motor drives a reversing gear mechanism to bring about the reversing movement of one or more wiper arms. In addition, the drive motor is controlled using a control unit which controls the drive torque by simple specification of pulse width modulation signals with a duty cycle. This control unit carries out a speed control based on a sensor-free position detection or sensor-free speed detection. In this manner, for the drive unit for the window wiper system only one control unit, a power unit, the drive motor and the reversing gear mechanism are required. Any relays for the stepped adjustment of the wiping speed, position sensors and speed sensors are not required.

Since in addition the wiping angles which are intended to be adjusted are predetermined by the reversing gear mechanism, for different vehicle types no change or parameterization or software change for the control unit is required and the drive unit can thereby be used in a modular manner for different vehicle types.

There may be provision for the control unit to be constructed to specify control signals to generate a predetermined rotary field through the phase conductors to start the window wiper system and, after the drive motor has been started up, to start the speed control based on the sensor-free position detection.

The control unit may further be constructed to carry out a blocking identification to identify a blocking of the drive motor depending on the phase currents.

According to an exemplary embodiment, the control unit may be constructed to carry out a temperature detection for a temperature of the drive motor depending on the phase currents and the applied phase voltages.

The control unit may further be constructed to associate with the predetermined operating function a desired speed of the rotor of the drive motor and to carry out the speed control depending on the desired speed.

According to another exemplary embodiment, a window wiper system having the above drive unit and a wiper unit is provided.

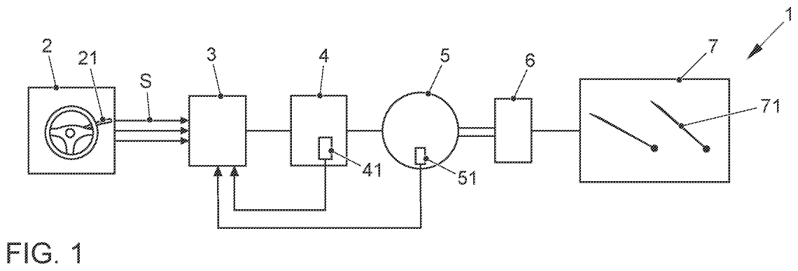

FIG. 1 shows a window wiper system 1 having a steering wheel arrangement 2, a control unit 3, a power unit 4, an electrically commutated drive motor 5, a reversing gear mechanism 6 and a wiper unit 7.

The steering wheel arrangement 2 has a steering column stalk 21 via which the window wiper system 1 can be switched on and off. Furthermore, the steering column stalk 21 enables stepped adjustment of the wiping speed and/or adjustment of an intermittent switching of the window wiper system 1. The corresponding adjustment of the operating function can be predetermined by the position of the steering column stalk 21 from the steering wheel arrangement 2 by one or more signal lines S on the control unit 3 of the window wiper system 1. The implementation of the operating mode is carried out in the control unit 3.

The drive motor 5 may be constructed as a multi-phase rotary motor and may, for example, be configured as a permanent-magnet-excited synchronous motor, asynchronous motor or the like. The drive motor 5 has a plurality of phase conductors to which a phase voltage is applied in each case in accordance with a commutation pattern to bring about a predetermined phase current. The phase current brings about the drive torque which is intended to be applied by the drive motor 5.

The reversing gear mechanism 6 is driven by the drive motor 5 and is coupled to the wiper unit 7 so that a specific wiping angle is travelled by the wiper arms 71 of the wiper unit 7. The reversing gear mechanism 6 enables the use in known manner of a drive motor 5 which is constructed as a rotary motor so that a change of the rotation direction of the drive motor 5 by corresponding control of the control unit 3 can be dispensed with. This enables position sensors for identifying an end movement position of the wiper arms 71 to be dispensed with and thus enables the processing complexity in the control unit 3 to be reduced.

The phase voltage is provided by the power unit 4. To control the drive motor 5, the control unit 3 provides control signals PWM to the power unit 4. The power unit 4 has a power driver module for each phase conductor of the drive motor 5 which may be constructed, for example, as an inverter or H-bridge circuit. As a result of the control of the power driver module using the control signals PWM provided by the control unit 3, alternately either a high supply potential or a low supply potential is applied to the respective phase conductor of the drive motor 5, wherein the durations predetermined by the duty cycles define the effective phase voltage.

The control unit 3 is configured to control the drive motor 5 via the power unit 4 using a pulse width modulation in such a manner that it provides a predetermined drive torque.

The commutation of the drive motor 5 can be carried out using a block commutation or sinusoidal commutation. To carry out a commutation of the drive motor 5, a position information item for a rotor position of the drive motor 5 is required. Consequently, by appropriate selection of the control signals PWM the drive motor 5 can be supplied with electrical power in such a manner that the orientation and strength of a stator magnetic field interacts with the rotor of the drive motor 5 in such a manner that the desired drive torque can be provided.

To detect the rotor position, a sensor-free detection principle can be used. This enables the provision of position sensors to be dispensed with to thus reduce the structural complexity. Sensor-free methods for detecting the rotor position may be based in a manner known per se on a back-EMF method or a method for measuring magnetic anisotropy. Both methods are based on an evaluation of the phase current paths with which it is possible to determine the rotor position.

The phase current paths can be detected by a current measurement of the phase currents. This can be carried out in the power unit, for example, using measurement resistors 41 which are connected in series with the phase conductors of the drive motor 5. As a result of the current flow through the measurement resistors 41, a measurement voltage drops over them and is detected by corresponding voltage measurement devices, such as, for example, analogue/digital converters, in the control unit 3 and is further processed to establish the rotor position using methods known per se for sensor-free rotor position determination.

The corresponding commutation pattern is now adjusted in accordance with the established rotor position so that a corresponding phase voltage is applied by the power unit 4 to the corresponding phase conductor of the drive motor 5.

There is further implemented in the control unit 3 a speed control which is carried out based on a rotation speed of the drive motor 5 which can be established from the change of the rotor position. To this end, using the steering column stalk 21, a desired speed or desired wiping speed is additionally predetermined and a corresponding function which is predetermined for a movement of the wiper arms 71 of the wiper arrangement 7 is selected in the control unit 3.

Consequently, in accordance with the control signals, a desired speed can be predetermined for the drive motor 5 in accordance with a desired wiping speed, and particularly during intermittent operation, it is possible to determine how long the speed control is active in the wiping phases. Reaching the end position (parking position) of the wiper arms 71 is implemented by an end position sensor 51 provided in the drive motor 5 or alternatively in the reversing gear mechanism 6, for example, as a sliding contact or Hall sensor.

The signal of the end position sensor 51 is evaluated in the power unit 4 or the control unit 3 and used to switch off the phase voltage. The speed control enables fluctuations of the supply voltage to be compensated for since this increases the drive torque of the drive motor 5 when the actual speed is lower than the desired speed, and vice versa. Torque fluctuations resulting from different friction resistances of the wiper arms 71 of the wiper unit 7 can also be adjusted.

Since the sensor-free rotor position detection or speed detection is reliably possible only from a specific speed, at the time at which the drive motor 5 is switched on, it is possible initially, that is to say, for example, for a predetermined period of time, for a rotary field which is defined independently of the position to be predetermined, and, whilst the rotor of the drive motor 5 is started up, the sensor-free position detection can be started.

The control unit 3 may further provide a blocking identification, wherein using the motor speed established by the sensor-free rotor position detection and the drive torque which is currently to be applied as a basis for calculation, wherein in the event of a significant deviation between the drive torque to be adjusted and a speed range which may therefore be anticipated and the real actual speed a blocking of the drive motor 5 or the wiper unit 7 is determined.

The control unit 3 may be arranged directly on the drive motor 5 or remote therefrom. In addition, as a result of the measurement of the phase current for the sensor-free position detection in conjunction with the voltage applied to the respective phase conductor a conclusion can be drawn regarding a temperature of the conductor of the phase conductor, that is to say, a temperature of the drive motor 5. Consequently, in addition, an overheating protection can be produced, in which the wiper unit 7 is throttled or switched off when the temperature of the drive motor 5 is above a predetermined threshold temperature.

### LIST OF REFERENCE NUMERALS

1 Window wiper system
2 Steering wheel arrangement
21 Steering column stalk
3 Control unit
4 Power unit
41 Measurement resistors
5 Drive motor
51 End position sensor
6 Reversing gear mechanism
7 Wiper unit
71 Wiper arms
S Signal line

1. A drive unit for a window wiper system of a transportation vehicle, the drive unit comprising:
an electronically commutated drive motor having a rotor and a plurality of phase conductors for providing a stator magnetic field;
a reversing gear mechanism coupled to the rotor of the drive motor to control one or more wiper arms of a wiper unit in a pivot movement with changing directions in response to a rotation of the rotor;
a power unit to provide phase voltages at the drive motor based on control signals and a device for measuring phase currents through the phase conductors; and
a control unit which is constructed, based on phase currents:
to carry out a sensor-free position detection of a rotor position of the rotor of the drive motor,
to generate the control signals based on the rotor position to provide a drive torque, and
to carry out a speed control based on a predetermined operating function.

2. The drive unit of claim 1, wherein the control unit generates the control signals as pulse width modulation signals to predetermine variable phase voltages using the power unit.

3. The drive unit of claim 1, wherein the control unit specifies control signals to generate a predetermined rotary field through the phase conductors to start the window wiper system and starts the speed control based on the sensor-free position detection in response to the drive motor being started.

4. The drive unit of claim 1, wherein the control unit carries out a blocking identification to identify a blocking of the drive motor based on the phase currents.

5. The drive unit of claim 1, wherein the control unit carries out a temperature detection for a temperature of the drive motor based on the phase currents and the applied phase voltages.

6. The drive unit of claim 1, wherein the control unit associates with the predetermined operating function a desired speed of the rotor of the drive motor and carries out the speed control based on the desired speed.

7. A window wiper system comprising the drive unit and the wiper unit of claim 1.
